(19) United States
(12) Patent Application Publication
(10) Pub. No.: US 2023/0242755 A1
(43) Pub. Date: Aug. 3, 2023

(54) POLYMER COMPOSITE COMPRISING WHOLE GRAIN FLOUR OF CEREAL GRASSES

(71) Applicant: CODA Intellectual Property B.V., s'Gravenhage (NL)

(72) Inventor: Daniel Eric Lynch, Rotterdam (NL)

(73) Assignee: CODA Intellectual Property B.V., s'Gravenhage (NL)

(21) Appl. No.: 18/193,403

(22) Filed: Mar. 30, 2023

Related U.S. Application Data
(63) Continuation of application No. PCT/NL2021/050594, filed on Sep. 29, 2021.

(30) Foreign Application Priority Data
Sep. 30, 2020 (NL) 2026596

(51) Int. Cl. C08L 67/04; C08K 5/1545; C08K 5/053; C08K 3/34; C08K 3/22; C08J 3/20; C08J 5/18

(52) U.S. Cl. CPC C08L 67/04; C08K 5/1545; C08K 5/053; C08K 3/34; C08K 3/22; C08J 3/203; C08J 5/18; C08L 2201/06; C08L 2205/06; C08L 2205/16; C08L 2205/03; C08L 2203/12; C08K 2003/2227; C08J 2367/04; C08J 2499/00

(57) ABSTRACT

The invention concerns a polymer composite comprising:

a. biodegradable polymer in an amount of 5-94.5% by weight of the overall weight;
b. whole grain flour of cereal grass in an amount of at least 5% by weight of the overall weight;
c. plasticizer in an amount from 5-50% w/w of component b);
d. optional filler, and
e. optional additive, wherein
c) is a solid plasticizer with a melting temperature in the range of 70 to 210° . The invention also concerns a process for its preparation, an intermediate, and a solid article comprising the polymer composite.

### CROSS REFERENCE TO RELATED APPLICATIONS

This application is a continuation of International Application No. PCT/NL2021/050594, filed on 29 Sep. 2021, which claims priority to Netherlands Application No. 2026596 NL, filed 30 Sep. 2020, the contents of each of which are hereby incorporated by reference in their entirety herein.

### TECHNICAL FIELD

This invention concerns a polymer composite comprising whole grain flour of grasses. More in particular, this invention concerns a polymer composite comprising an increased amount of whole grain flour of cereal grasses.

### BACKGROUND

Grasses have stems that are hollow except at the nodes and narrow alternate leaves borne in two ranks. The lower part of each leaf encloses the stem, forming a leaf-sheath. The leaf grows from the base of the blade, an adaptation allowing it to cope with frequent grazing. Cereal grasses include staple crops such as maize, wheat, rice, barley, oat and millet as well as feed for animals, such as canary seeds. Moreover, they include hybrids, such as triticale. The flour in this case is made of the whole grain (groat) or seed, including the hull and/or husk. Within this specification, the definition of grain includes groats, which are the hulled kernels of cereal grains, that include the cereal germ and fibre-rich bran portion of the grain, as well as the endosperm.

Triticale (Triticosecale) is a wheat rye hybrid with wheat used as the female parent and rye used as the pollen donor. Triticale grain has a higher protein content than wheat, having a crude protein content of 13.1% against 12.3% in wheat. Triticale starch content ranges between 60-70%. In the UK there are two main variants, winter and spring triticale.

Oats (Ave a sativa) are a whole grain cereal covered in an outer husk, which needs to be removed before consumption of the grain. Whole oats (or oat groats) contain 10-13% protein and are a good source of dietary fibre. Starch content can vary from 40-50%. Oat husks make up 25-33% of the weight of the grain and are high in fibre. Similar to triticale, oats are grown in the UK in two main variants, winter and spring, with multiple varieties within these two groupings include both husked and naked (huskless) types.

Millet describes a series of small-seeded grasses of which there are six commonly cultivated types: Finger millet (Eleusine coracana); Proso millet (Panicum miliaceum); Little millet (Panicum sumatrense); Foxtail millet (Setaria italica); Pearl millet (Pennisetum glaucum); and Sorghum (Great millet-Sorghum bicolor). Millet contains between 8.5-15% protein, and up to 70% starch, dependent on variety.

Canary Seed (Phalaris canariensis) is an annual grass with two main variants: itchy and hairless (glabrous). Canary seed varieties contain approximately 20-30% protein, considered extremely high in protein when compared against similar cereal grains, and around 60% starch.

With the addition of an appropriate plasticiser, a chemical that is mixed with e.g. milled triticale, with the purpose of preventing their inherent starch/protein chains from agglomerating, the plasticized powder can form a plastic composite with an appropriate polymer with high percentages of inclusion. The purpose of such is to either reduce fossil fuel based plastic content and/or create biodegradable/compostable composites with similar polymers.

That starch may be plasticized is known. For instance, from ACS Appl. Polym. Mater, 2020, 2, 2016-2026 it is known that glycerol outperforms sorbitol when plasticizing amylopectin starch. Polymer mixtures comprising either starch or protein isolate from cereal grasses are known, but this requires the removal of the husk and/or hull, as well as the additional step of isolating and/or chemically modifying the starch or protein. For instance, from J. Appl. Polym Sci 2011, 119, 24-39-2448, a comparison is known of sorbitol and glycerol as plasticizers for thermoplastic starch (TPS) in blends of TPS and polylactic acid (PLA). This study revealed that sorbitol as plasticizer for starch unfortunately has limited use because of its tendency to migrate to the surface and by its recrystallization over time. The materials thus eventually lose their homogeneity and become brittle. In contrast, polymer composites comprising the hulls from oats and millet are also known, but only from the respective hulls. Of greater commercial interest are polymer composites using whole grain flour of cereal grasses, e.g., the milled whole seeds of triticale and oats.

Chemically treated oat hull fibre have been compounded up to 30% w/w into both poly(lactic acid) (PLA) and polycaprolactone (PCL) and then pressed into solid articles using compression moulding techniques, presented by R. K. Grewal, M. Soleimani and L. G. Tabilat in a paper entitled “Investigations on biocomposites from oat hull and biodegradable polymers” at the CSBE/SCGAB 2015 Annual Conference (paper no. CSBE15-019).

Millet husk fibre has also been compounded into PLA at loading levels of 10, 20, 30, and 40% w/w: A. A. Hammajam, A. M. EI-Jummah, and Z. N. Ismarrubie, “The Green Composites: Millet Husk Fiber (MHF) Filled Poly Lactic Acid (PLA) and Degradability Effects on Environment”, Open Journal of Composite Materials, 2019, 9, 300-311.

Millet flour has been incorporated with other natural ingredients to create a resin: A. A. Mohamed, S. Hussain, M. S. Alamri, M. A. Ibraheem, and A. A. Abdo Qasem, “Thermal Degradation and Water Uptake of Biodegradable Resin Prepared from Millet Flour and Wheat Gluten Crosslinked with Epoxydized Vegetable Oils”, Journal of Chemistry 2019, Article ID 7050514, 12 pages.

In Japanese patent publication JP2009/286933A, films of 100 micrometer thick have been fabricated using a resin composition including starch or wheat flour as a plant-derived component, a polymer, and a solid plasticizer.

In US2012/0135169A1, compositions including a biopolymer, a flour with reduced amounts of ash, germ, bran and fiber compared to meal or whole-grain flour, and a plasticizer are used to produce a biodegradable bioplastic material.

The purpose of the present invention is to find a solution that allows inclusion of greater amounts of whole grain flour of cereal grasses, e.g. milled whole seeds of for instance triticale and oats, without loss of strength or flexibility. Moreover, the purpose of the present invention is to find polymer composites that can be moulded, e.g., into disposable articles such as coffee capsules, cutlery, straws, drink stirrers, food trays, single-serve packaging such as a cup, cap, container and/or lid, or any other single-use item, etc., i.e. with sufficient strength to form a disposable article with a wall thickness larger than 250 micrometres, whereas the polymer composites are biodegradable.

### SUMMARY OF THE INVENTION

A polymer composite is provided as claimed in claim 1, comprising.
a. biodegradable polymer in an amount of 5-94.5% by weight of the overall weight;
b. whole grain flour of cereal grasses in an amount of at least 5% by weight of the overall weight;
c. plasticizer in an amount from 5-50% w/w of component b);
d. optional filler, and
e. optional additive,
   wherein
   c) is a solid plasticizer with a melting temperature in the range of 70 to 210° C.

Also provided is a process for preparing the polymer composite, an intermediate for preparing the polymer composite and articles comprising the polymer composite.

### DETAILED DESCRIPTION OF THE INVENTION

It has been found that with the addition of at least 5%, preferably at least 15% by weight of a solid plasticizer based on the whole grain flour of cereal grasses, optionally together with an appropriate filler, the whole grain flour of cereal grasses can form a plastic composite material with a polymer even at high loading levels, e.g., higher than 20% w/w or even higher than 40% w/w based on the whole grain flour of cereal grass and polymer, with sufficient strength to form a disposable article with a wall thickness larger than 250 micrometres (10 mils), and sufficient biodegradability.

For use in the present invention, any type of cereal grass as defined above can be used as component b). This current invention specifically focusses on whole grain flour of cereal grasses based on any one or more of triticale, oats, millet, and canary seed. Prior to compounding, the whole grain of cereal grass, including husk and/or hull, is milled to a fine powder, having a particle size smaller than 1 mm, preferably smaller than 500 micrometres. This is preferably done in multiple stages to obtain a uniform small particle size. For instance, milled whole grain triticale powder may be used. Similar considerations apply with respect to oats, millet, and canary seed or combinations thereof.

Whole-grain flour in this specification is made of the whole grain (groat) or seed, wherein grain includes groats, which are the hulled kernels of cereal grains, that include the cereal germ and fibre-rich bran position of the grain, as well as the endosperm. The whole-grain flour preferably includes native (non-reconstituted) whole-grain flour only. Reconstituted flour is a composition obtained by simply mixing of the individual, pure components of native whole-grain flour in the respective amounts.

Milling is preferably carried out on dry material e.g. in order to more easily obtain a uniform small particle size and/or to reduce the amount of introduced liquid such as water. In an embodiment, materials may thus be dried prior to milling. Hence, although in this specification, materials may only be referred to as being milled, the present invention alternatively or additionally refers to embodiments in which the materials are dried milled and thus, if necessary, the wording “milled” may be replaced throughout the specification by the wording “dried milled” where appropriate. In other words, “milled” has to be interpreted as meaning “milled and/or dried milled” unless specifically stated otherwise.

The whole grain flour of cereal grass may be used at low loading levels, starting at 5% by weight of the overall weight, but preferably is used at loading levels in excess of 20%, e.g., at loading levels of 20-90%, more preferably at loading levels of 20-80%, still more preferably at loading levels of 20-70% by weight of the overall weight, or at loading levels in excess of 40%, e.g., at loading levels of 40-90%, more preferably at loading levels of 40-80%, still more preferably at loading levels of 40-70% by weight of the overall weight. The whole grain flour of cereal grass may be mixed, e.g., up to 100%, preferably up to 50% by weight of component b), with milled expeller/meal/cake, milled pomace, milled distillers' grain, milled brewer's grain (or brewer's spent grain/draff), milled biscuit meal (or biscuit cereal meal), coffee grounds, milled whole seeds, milled whole roots, milled whole beans, milled stems and/or leaves, and flour of pulse, or combinations thereof. For instance, a mixture of two materials such as milled triticale and either rosehip meal, or areca catechu leaf sheath powder may be used, or a mixture of two materials such as milled triticale and either borage meal, or Ahiflower meal may be used. When mixing the whole grain flour of cereal grass with expellers, meals, and the like, the amount of solid plasticizer is calculated on amount of the whole grain flour of cereal grass.

Suitable expellers may include but are not limited to the expeller of sunflower seeds, rapeseed, linseed, peanut, palm fruit, sesame seed, castor seed, and sugar beet pulp. Suitable meals may include but are not limited to the meal of sunflower, borage, cottonseed, Buglossoides arvensis (Ahiflower), safflower, rosehip, canola, blackcurrant, palm kernel, rapemeal, and evening primrose. Biscuit meal, or biscuit cereal meal, may include either a mixture of or the individual components of the crumbed waste of cooked and processed biscuit, cake and cereal food products. Pulses include annual leguminous crops yielding from one to twelve grains or seeds of variable size, shape and color within a pod, that are used for both food and feed and that are harvested solely for dry seed, such as field peas, faba beans and lupin beans. Suitable examples of pomace may include grape pomace, olive pomace, apple pomace, or the solid remains of other fruits or vegetables after pressing for juice or oil.

The biodegradable polymer may be mixed, e.g., up to 100%, preferably up to 50% by weight of component a), with any polymer. Suitable polymers to mix with the biodegradable polymer include synthetic and natural polymer, e.g., biobased and biodegradable polymers, but preferably a thermoplastic polymer is used.

The polymer composite may be made from any biodegradable polymer as component a), but preferably a thermoplastic polymer is used.

Suitable thermoplastic materials, either as biodegradable polymer or as polymer for mixing with the biodegradable polymer, include polyamides (such as nylon), acrylic polymers, polystyrenes, polypropylene (PP), polyethylene (including low-density polyethylene (LDPE) and high density polyethylene (HDPE), acrylonitrile butadiene styrene (ABS), polyglycolic acid, polycarbonates, polybenzimidazole, poly ether sulphone, polyether ether ketones (PEEK), polyetherimide, polyphenylene oxide, polyphenylene sulphide, polyvinyl chloride, and polytetrafluoroethylene, or any suitable mixture thereof.

Elastomers, or combinations of thermoplastic polymers with elastomers may also be used. Suitable elastomers, either as biodegradable elastomer or as elastomer for mixing with the biodegradable polymer, include natural and synthetic rubbers, chloroprene, neoprene, isoprene, polybutadiene, butyl rubber, halogenated butyl rubber, styrene-butadiene, nitrile rubber, latex, fluoroelastomers, silicone rubbers, epichlorhydrin, poly ether block amides, ethylene vinyl acetate (EVA) and ethylene vinyl alcohol (EVOH) for example. The elastomer may comprise a thermoplastic elastomer, which may be selected from styrenic block copolymers (TPE-s), thermoplastic olefins (TPE-o), elastomeric alloys (TPE-v or TPV), thermoplastic polyurethanes (TPU), thermoplastic copolyester (TPE-E) and thermoplastic polyamides, for example.

Thermoset polymers, or combinations of thermoplastic polymers with thermoset polymers may also be used. Suitable thermoset polymers, either as biodegradable polymer or as polymer for mixing with the biodegradable polymer, include epoxy resins, melamine formaldehyde, polyester resins and urea formaldehyde, for example.

Suitable acrylic polymers (which may be thermoplastics, thermosets or thermoplastic elastomers), either as biodegradable polymer or as polymer for mixing with the biodegradable polymer, include polyacrylic acid resins, polymethyl methacrylates, polymethyl acrylates, polyethyl acrylates, polyethyl ethacrylates, and polybutyl methacrylates, for example.

Suitable polyesters, either as biodegradable polymer or as polymer for mixing with the biodegradable polymer, include polyglycolide (PGA), polylactide or poly(lactic acid) (PLA), poly(lactide-co-glycolide) (PLGA), polycaprolactone (PCL), poly(butylene succinate) (PBS) and its copolymers, e.g. poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB) or other polyhydroxyalkanoates (PHA), poly(hydroxybutyrate-co-hydroxyvalerate) (PHBV), or any suitable mixture thereof. Most preferably either PLA or PBS is used as component a). Most preferably, for improved biodegradability, the polymer composite comprises either PLA or PBS in an amount between 30-50% w/w of the overall mixture.

Plasticizers are an important class of low molecular weight non-volatile compounds that are widely used in polymer industries as additives. Plasticizers for thermoplastics are, in general, high boiling point liquids, with average molecular weights of between 300 and 600, and linear or cyclic carbon chains (14-40 carbons). However, the purpose of the plasticizer for a biomaterial is to prevent agglomeration of the carbohydrate/protein chains so that the biomaterial mixes with the polymer and the two become a single plastic mass. For the purpose of the present invention, the plasticizer must be compatible with component b), and be different from component b).

Whereas in the prior art glycerol is used, the present invention requires the use of a solid plasticizer with a melting temperature in the range of 55 to 210° C., preferably in the range of 70 to 210° C., even more preferably in the range of 80 to 210° C., and most preferably in the range of 90 to 210° C. The plasticizer may be selected from polyols, polyfunctional alcohols, amphipolar plasticizers such as carboxylic acids and esters, for instance mono, di-, and tri-glyceride esters; mono-, di- and oligosaccharides and combinations thereof. Polyols have been found to be particularly effective. Suitable plasticizers include sorbitol, maltitol, sucralose, threitol, erythritol, psicose, allose, talose, ribitol, tagatose, arabinose, galactitol, lactitol, arabitol, glyceraldehyde, iditol, sorbose, ribose, galactose, volemitol, mannitol, fucitol, xylose, xylitol, trehalose, cellobiose, raffinose, glucose, mannose, fructose, isomalt, polydextrose and sucrose; and/or combinations thereof. For instance, xylose, with a melting point of 144-145° C. and/or sorbitol, with a melting point of 94-96° C., and/or xylitol, with a melting point of 92-96° C. may be used. An advantage of using sorbitol over xylose is the higher tensile strength of the resulting polymer composite. An advantage of using xylitol over sorbitol and xylose is the higher tensile strength of the resulting polymer composite. Further, xylitol has a lower solubility in water then sorbitol meaning that when the polymer composite is used in solid articles that during use are subjected to water, e.g., hot water, as in a coffee machine, the chance of xylitol being dissolved into the water is lower.

Also, a mixture of a solid plasticizer and a liquid plasticizer may be used, provided the mixture has a melting temperature in the range of 55 to 210° C., preferably in the range of 70 to 210° C., even more preferably in the range of 80 to 210° C., and most preferably in the range of 90 to 210° C. The amount of liquid plasticizer is preferably small, e.g., up to 10% by weight of component c).

The plasticizer may be used in an amount from 15-50% w/w of component b), preferably between 22-40% w/w of component b).

Additional, optional components of the polymer composite include fillers, such as mineral fillers and/or natural fibres and/or carbon-based fillers.

Suitable mineral fillers include carbonates (including bicarbonates), phosphates, ferrocyanides, silica, silicates, aluminosilicates (including all forms of clay minerals, mica and talc), titanium dioxide, or combinations thereof. For instance, a nepheline syenite may be used or any similar filler derived from silica-undersaturated and peralkaline igneous rocks, as well as any type of bentonite.

Natural fibres include cellulose or lignocellulosic fibres such as plant or vegetable fibres from the blast, leaf, seed, wood, or stem. For instance, wood cellulose fibre may be used. Carbon based fillers include carbon nanotubes (CNT), graphene, fullerene, graphite, and amorphous carbon.

The filler may be used in an amount from 0-96% w/w of the overall mixture, preferably between 1-40% w/w of the overall mixture.

Optional additional components include compatibilizers, fragrances, heat and UV stabilizers, coloring agents and the like. Suitable compatibilizers include any acrylic grafted thermoplastics (for example: maleic anhydride grafted polyethylene, polypropylene, or polylactic acid), interface-active high-molecular-weight peroxides, poly(2-ethyl-2-oxazoline), any esters of citric add, aromatic carbodiimides (for example: BioAdimide from Lanxess), wax-based emulsion additives (for exarnple: Aquacer from BYK Additives), organo-silane coupling agents, and isocyanate (or diisocyanate) coupling agents (for example: methylenediisocyanate).

The additional components may be used in an amount from 0-30% by weight of the overall mixture, preferably between 0-15% by weight of the overall mixture.

The polymer composite is made by so-called “hot compounding” techniques, where the components are combined under heat and shearing forces that bring about a state of molten plastic (fluxing) which is shaped into the desired product, cooled and allowed to develop ultimate properties of strength and integrity. Hot compounding includes calendering, extrusion, injection and compression moulding. This is carried out at temperatures, pressures and processing conditions specific to the selected polymer. For instance, when using PLA the temperature is preferably in the range of 130 to 215° C., more preferably in the range of 130 to 210° C., even more preferably between 130 to 185° C., and most preferably between 130 to 165° C.

The polymer composite may also be made by a multistep process, wherein the whole grain flour of cereal grass is first compounded with the solid plasticizer and pelletized and the pellets or grinded pellets are then combined with the polymer. Additional components may be added in any of the steps of the multistep process. The present invention therefore also provides pellets or grinded pellets of whole grain flour of cereal grass compounded and pelletized with plasticizer and other components if any, as intermediate product for combination with the polymer to produce the polymer composite.

The result of the process can be in the form of a solid article (or layer or portion thereof) and may comprise a compounded pellet, extruded work-piece, injection-moulded article, blow moulded article, rota-moulded plastics article, two-part liquid moulded article, laminate, 3D printer filament, felt, woven fabric, knitted fabric, embroidered fabric, nonwoven fabric, geotextiles, fibres or a solid sheet, for example.

The solid article may be in the form of a coffee capsule, cutlery, straw, drink stirrer, food tray, or single-serve packaging, such as a cup, cap, container and/or lid, or any other single-use item.

The solid article is preferably suited to be used and/or cleaned in water environments with a temperature above room temperature, preferably a temperature above 30° C., more preferably a temperature above 50° C., even more preferably a temperature above 60° C., and most preferably a temperature above 80° C. The solid article may for instance be used in a coffee machine using water at a temperature between 80 to 100° C., e.g., between 87 and 92° C.

The solid article is preferably suited to be used under pressure, e.g., a pressure above 2 bar, preferably a pressure above 4 bar, more preferably a pressure above 6 bar, and most preferably a pressure above 8 bar, e.g. as used in a coffee machine.

The solid article preferably has a minimum thickness above 250 micrometres, preferably above 350 micrometres, more preferably above 500 micrometres, and most preferably above 600 micrometres.

The invention is illustrated by the below examples.

### Example 1

275 grams of PLA (Ingeo® 3251D from Natureworks LLC), 225 grams of whole-grain winter triticale flour milled in a laboratory grain mill grinder and 67.5 grams of xylose powder (sieved through a 1 mm sieve) were mixed in a sealed plastic bag into a homogenous mixture (Mixture 1).

### Example 2

275 grams of Ingeo 3251D PLA, 225 grams of whole-grain oat flour milled in a laboratory grain mill grinder and 67.5 grams of xylose powder (sieved through a 1 mm sieve) were mixed in a sealed plastic bag into a homogenous mixture (Mixture 2).

### Example 3

275 grams of Ingeo 3251D PLA, 225 grams of whole-grain foxtail millet flour milled in a laboratory grain mill grinder and 67.5 grams of xylose powder (sieved through a 1 mm sieve) were mixed in a sealed plastic bag into a homogenous mixture (Mixture 3).

### Example 4

275 grams of Ingeo 3251D PLA, 225 grams of whole-grain hairless canary seed flour milled in a laboratory grain mill grinder and 67.5 grams of xylose powder (sieved through a 1 mm sieve) were mixed in a sealed plastic bag into a homogenous mixture (Mixture 4).

### Example 5

275 grams of Ingeo 3251D PLA, 225 grams of whole-grain winter triticale flour milled in a laboratory grain mill grinder and 67.5 grams of sorbitol powder (sieved through a 1 mm sieve) were mixed in a sealed plastic bag into a homogenous mixture (Mixture 5).

### Example 6

275 grams of Ingeo 3251D PLA, 225 grams of whole-grain oat flour milled in a laboratory grain mill grinder and 67.5 grams of sorbitol powder (sieved through a 1 mm sieve) were mixed in a sealed plastic bag into a homogenous mixture (Mixture 6).

### Example 7

275 grams of Ingeo 3251D PLA, 225 grams of whole-grain foxtail millet flour milled in a laboratory grain mill grinder and 67.5 grams of sorbitol powder (sieved through a 1 mm sieve) were mixed in a sealed plastic bag into a homogenous mixture (Mixture 7).

### Example 8

275 grams of Ingeo 3251D PLA, 225 grams of whole-grain hairless canary seed flour milled in a laboratory grain mill grinder and 67.5 grams of sorbitol powder (sieved through a 1 mm sieve) were mixed in a sealed plastic bag into a homogenous mixture (Mixture 8).

### Example 9

275 grams of Ingeo 3251D PLA, 225 grams of whole-grain winter triticale flour milled in a laboratory grain mill grinder and 67.5 grams of xylitol powder (sieved through a 1 mm sieve) were mixed in a sealed plastic bag into a homogenous mixture (Mixture 9).

### Example 10

275 grams of Ingeo 3251D PLA, 225 grams of whole-grain oat flour milled in a laboratory grain mill grinder and 67.5 grams of xylitol powder (sieved through a 1 mm sieve) were mixed in a sealed plastic bag into a homogenous mixture (Mixture 10).

### Example 11

275 grams of Ingeo 3251D PLA, 225 grams of whole-grain foxtail millet flour milled in a laboratory grain mill grinder and 67.5 grams of xylitol powder (sieved through a 1 mm sieve) were mixed in a sealed plastic bag into a homogenous mixture (Mixture 11).

### Example 12

275 grams of Ingeo 3251D PLA, 225 grams of whole-grain hairless canary seed flour milled in a laboratory grain mill grinder and 67.5 grams of xylitol powder (sieved through a 1 mm sieve) were mixed in a sealed plastic bag into a homogenous mixture (Mixture 12).

### Example 13

150 grams of Ingeo 3251D PLA, 192 grams of whole-grain winter triticale flour milled in a laboratory grain mill grinder, 58 grams of xylitol powder (sieved through a 1 mm sieve) and 100 grams of borage meal powder milled in the same grinder were mixed in a sealed plastic bag into a homogenous mixture (Mixture 13).

### Example 14

150 grams of Ingeo 3251D PLA, 192 grams of whole-grain winter triticale flour milled in a laboratory grain mill grinder, 58 grams of xylitol powder (sieved through a 1 mm sieve) and 100 grams of (Ahiflower) bugglossoides meal powder milled in the same grinder were mixed in a sealed plastic bag into a homogenous mixture (Mixture 14).

### Example 15

150 grams of Ingeo 3251D PLA, 192 grams of whole-grain winter triticale flour milled in a laboratory grain mill grinder, 58 grams of xylitol powder (sieved through a 1 mm sieve) and 100 grams of Hifill N800 (nepheline syenite powder from Sibelco UK Ltd) were mixed in a sealed plastic bag into a homogenous mixture (Mixture 15).

### Example 16

150 grams of Ingeo 3251D PLA, 192 grams of whole-grain winter triticale flour milled in a laboratory grain mill grinder, 58 grams of xylitol powder (sieved through a 1 mm sieve) and 100 grams of Premium QuestTM Bentonite (calcium bentonite powder as inorganic filler from Amcol Minerals Europe Ltd) were mixed in a sealed plastic bag into a homogenous mixture (Mixture 16).

### Example 17

115.4 grams of whole-grain winter triticale flour milled in a laboratory grain mill grinder, 34.6 grams of xylitol powder (sieved through a 1 mm sieve) and 350 grams of compounded pellets containing 60% Ingeo 3251D PLA and 40% wood cellulose fiber (supplied by Sappi Maastricht BV) were mixed in a sealed plastic bag into a homogenous mixture (Mixture 17).

### Example 18

115.4 grams of whole-grain oat flour milled in a laboratory grain mill grinder, 34.6 grams of xylitol powder (sieved through a 1 mm sieve) and 350 grams of compounded pellets containing 60% Ingeo 3251D PLA and 40% wood cellulose fiber (supplied by Sappi Maastricht BV) were mixed in a sealed plastic bag into a homogenous mixture (Mixture 18).

### Example 19

115.4 grams of whole-grain hairless canary seed flour milled in a laboratory grain mill grinder, 34.6 grams of xylitol powder (sieved through a 1 mm sieve) and 350 grams of compounded pellets containing 60% Ingeo 3251D PLA and 40% wood cellulose fiber (supplied by Sappi Maastricht BV) were mixed in a sealed plastic bag into a homogenous mixture (Mixture 19).

### Example 20

115.4 grams of whole-grain winter triticale flour milled in a laboratory grain mill grinder, 34.6 grams of sorbitol powder (sieved through a 1 mm sieve) and 350 grams of compounded pellets containing 40% Ingeo 3251D PLA and 60% wood cellulose fiber (supplied by Sappi Maastricht BV) were mixed in a sealed plastic bag into a homogenous mixture (Mixture 20).

### Examples 21-40

Mixtures 1-20 (from Examples 1-20) were individually poured into the hopper of a Negri Bossi v55 injection moulding machine with a 32 mm diameter screw and a L/D ratio of 20:1 operating at temperatures ranging from 130 to 165° C. Each molten plasticized mixture was injection moulded in a single-cavity tool fitted with a single-drop hotrunner system into capsules suitable for use in a Nespresso®-style coffee machine.

### Example 41

50 kgs of whole winter triticale seeds were milled in a Magico EMC70 electric mill from AMA S.p.A. fitted with a 1 mm sieve. The resultant flour was then mixed with 30% by weight of xylitol in a tumble mixer to create a mixed powder of about 65 kgs weight. This mixture was then compounded with Ingeo 3251D PLA in a ratio of 64:36 triticale/xylitol:PLA on a Werner and Pfleiderer ZSK 25 twin-screw compounder fitted with a ZS-B 25 twin-screw side feeder. The screw profile used is given in Table 1 along with the respective injection points for the component materials. The temperature settings along the barrel were 170, 190, 170, 170, 170, 170, 170, 170° C. The compounded filament was cooled in a water bath, dried under an air knife and pelletized using a SG-E 60 from Intelligent Pelletizing Solutions GmbH & Co KG. Pellets were dried overnight in a Dryplus 250 from Vismec s.r.l at 80° C.

TABLE 1
Screw profile with material inclusion points

| | | |
|---|---|---|
| Conveying | 16/16 | (PLA) |
| | 36/36 (×2) | |
| | 36/18 | |
| | 36/36 | |
| | 36/18 | |
| Kneading | 45/5/36 | |
| | 45/5/18 | |
| | 45/5/18 (×2) | |
| Conveying | 36/36 (×5) | (triticale/xylitol) |
| Kneading | 45/5/36 (×3) | |
| Conveying | 36/36 | |
| Kneading | 45/5/24 (×3) | |
| Conveying | 16/16 | |
| | 36/36 (×2) | |
| Kneading | 45/5/12 (×2) | |
| | 90/5/24 | |
| Conveying | 36/36 | |
| Kneading | 45/5/12 (×2) | |
| | 45/5/12 | |
| Conveying | 36/36 (×5) | |
| | 24/24 (×4) | |

### Example 42

50 kgs of whole oats were milled in a Magico EMC70 electric mill from AMA S.p.A. fitted with a 1 mm sieve. The resultant flour was then mixed with 30% by weight of sorbitol in a tumble mixer to create a mixed powder of about 65 kgs weight. This mixture was then compounded with Ingeo 3251D PLA in a ratio of 64:36 oats/sorbitol:PLA on a Werner and Pfleiderer ZSK 25 twin-screw compounder fitted with a ZS-B 25 twin-screw side feeder. The screw profile used is given in Table 1 and the respective injection points for the component materials were as per Example 41. All other details were as per Example 41.

### Examples 43-44

Compounded pellets from Examples 41 and 42 were separately mixed in equal weight portions with compounded pellets containing 60% Ingeo 3251D PLA and 40% wood cellulose fiber (supplied by Sappi Maastricht BV) and fed into the hopper of a Krauss Maffei 120-180 PX injection moulding machine with a 25 mm diameter screw operating at temperatures ranging from 200 to 215° C. Each molten plasticized mixture was injection moulded in an eight-cavity tool fitted with a valve-gate hotrunner system into capsules suitable for use in a Nespresso®-style coffee machine.

### Example 45

Compounded pellets of BioPBS FZ71 PM (PTT MCC Biochem Company Ltd) and Minex S4 (nepheline syenite powder from Sibelco UK Ltd) in a ratio of 70:30 respectively were prepared on a Werner and Pfleiderer ZSK 25 twin-screw compounder fitted with a ZS-B 25 twin-screw side feeder as per Example 41 except that all of the barrel temperatures were set 10° C. higher. The dried pellets were then re-compounded with the same triticale/xylitol mixture as per Example 41 in a ratio of 70:30 with all other details as per Example 41.

### Example 46

Compounded pellets of Ingeo 3251D PLA and Minex S4 (nepheline syenite powder from Sibelco UK Ltd) in a ratio of 70:30 were prepared on a Werner and Pfleiderer ZSK 25 twin-screw compounder fitted with a ZS-B 25 twin-screw side feeder as per Example 41. The dried pellets were then re-compounded with the same triticale/xylitol mixture as per Example 41 in a ratio of 70:30 with all other details as per Example 41.

### Examples 47-48

Compounded pellets from Examples 45 and 46 were separately fed into the hopper of a Krauss Maffei 120-180 PX injection moulding machine with a 25 mm diameter screw operating at temperatures ranging from 200 to 215° C. Each molten plasticized mixture was injection moulded in an eight-cavity tool fitted with a valve-gate hotrunner system into capsules suitable for use in a Nespresso®-style coffee machine.

### Example 49

Representative coffee capsules from Examples 21-40 were filled to level capacity with ground coffee grains and sealed with self-sealing aluminium coffee capsule lids. Filled capsules were then tested in a standard Nespresso coffee machine to produce a volume of filtered coffee. All capsules tested produced approximately the same volume of coffee as expelled from a commercial Nespresso capsule.

### Example 50

Representative coffee capsules from Examples 43, 44, 47 and 48 were filled to level capacity with ground coffee grains on a commercial filling line (Spreafico Srl) and sealed using Green Capsule top lids (Ahlstrom-Munksjo Oyj). Filled capsules were then tested in a standard Nespresso coffee machine to produce a volume of filtered coffee. All capsules tested produced approximately the same volume of coffee as expelled from a commercial Nespresso capsule.

### Example 51-52

Compounded pellets from Examples 41 and 42 were separately mixed in equal weight portions with compounded pellets containing 60% Ingeo 3251D PLA and 40% wood cellulose fiber (supplied by Sappi Maastricht) and separately poured into the hopper of a Negri Bossi v55 injection moulding machine with a 32 mm diameter screw and a L/D ratio of 20:1 operating at temperatures ranging from 165 to 185° C. Each molten plasticized mixture was injection moulded in a twin-cavity tool fitted with a single-drop hotrunner system into drink stirrer sticks suitable for stirring beverages.

### Example 53

Fifteen capsules (weight: 2.72±0.01 g) from Example 43 were mixed into 2 kgs of commercially purchased topsoil (passed through a 4 mm sieve) containing enough distilled water to saturate (defined by not leaving any standing water) the soil in a 5 L Pyrex glass beaker covered with 20 cm diameter watch glass. The beaker was placed inside a Unitemp temperature controlled oven set at 58° C. (as per the thermophilic incubation period as detailed in IS020200-2015). The trial was left undisturbed for separate periods of 21 days up to a total of 90 days. Upon extraction and cooling to room temperature of the glass beaker at the end of each 21 day trial period, the soil was carefully broken apart to extract any intact capsules. Following extraction of both capsules and the larger pieces of broken capsules the soil was again sifted through a 4 mm sieve to extract any remaining pieces. All capsules were dried and then carefully brushed with a toothbrush to remove any attached dirt before being photographed and returned to re-saturated soil for another 21 day trial period until the end of the 90 day trial period. At the end of the 90 day trial period all capsules had disintegrated into pieces with less than 25% by weight not passing through a 4 mm sieve.

### SUMMARY

Examples 1-12 illustrate polymer composites with a high loading of whole-grain flour of cereal grass. In example 13 the combination of flour of cereal grasses with borage meal is illustrated, whereas in Example 14 the combination with Ahiflower meal is illustrated. In Examples 15-16 and 45-46 inorganic filler materials have been used whereas in Examples 17-20 and 43-44 cellulose filler has been used.

All formulations allowed the preparation of a disposable article, in this case a coffee capsule, and also a drink stirrer for Examples 51 and 52. The coffee capsules were strong enough to be used in a Nespresso® coffee machine, as shown in Examples 49 and 50. Moreover, the coffee capsules made from a triticale/wood cellulose mixture proved to be highly biodegradable, as shown in Example 53.

The invention can be summarized by the following clauses:
1. Polymer composite comprising:
   a. polymer in an amount of 5-94.5% by weight of the overall weight;
   b. whole grain flour of cereal grass, in an amount of at least 5% by weight of the overall weight;
   c. plasticizer in an amount from 5-50% w/w of component b);
   d. optional filler, and
   e. optional additive,
      wherein
      c) is a solid plasticizer with a melting temperature in the range of 55 to 210° C.
2. Polymer composite according to clause 1, wherein component a) comprises a biodegradable polymer, preferably PLA, or derivatives or polymer blends thereof.
3. Polymer composite according to clause 2, wherein component a) is present in an amount of 30-70% by weight of the overall weight, preferably in an amount of 30-50% by weight of the overall weight.
4. Polymer composite according to any of the preceding clauses, wherein component b) comprises milled whole triticale seeds, or milled whole oat groats, or milled whole millet seeds, or milled whole canary seeds, or a mixture thereof.
5. Polymer composite according to any of the preceding clauses, comprising a mixture of whole grain flour of cereal grass and up to 50% w/w of component b) of milled expeller/meal/cake, milled pomace, milled distillers' grain, milled brewer's grain (or brewer's spent grain/draff), milled biscuit meal or individual components thereof, milled whole seeds, milled whole roots, milled whole beans, milled stems and/or leaves, flour of pulse, or a mixture thereof.
6. Polymer composite according to any of the preceding clauses, wherein component b) or the mixture of claim 5 is present in an amount of 30-70% by weight of the overall weight.
7. Polymer composite according to any of the preceding clauses, comprising polyols, polyfunctional alcohols, amphipolar plasticizers such as carboxylic acids and esters, for instance mono, di-, and tri-glyceride esters; mono-, di- and oligosaccharides, or mixtures thereof, as component c).
8. Polymer composite according to any of the preceding clauses, wherein component c) is present in an amount from 22 to 40% w/w of component b).
9. Polymer composite according to any of the preceding clauses, comprising as component d) either a natural fibre, preferably cellulose or lignocellulose fibres, and/or a mineral filler preferably selected from carbonates (including bicarbonates), phosphates, ferrocyanides, silica, silicates, aluminosilicates (including all forms of clay minerals and talc), titanium dioxide, and/or a carbon-based filler, or combinations thereof.
10. Polymer composite according to any of the preceding clauses, wherein component d) is present in an amount from 1-40% by weight of the overall weight.
11. Polymer composite according to any of the preceding clauses, comprising compatibilizers, fragrances, heat and UV stabilizers, and/or coloring agents or a mixture thereof as additive.
12. A process for preparing the polymer composite according to any of the preceding clauses, wherein the polymer composite is made by hot compounding techniques, where the components are combined under heat and shearing forces that bring about a state of molten plastic (fluxing) which is shaped into the desired product, cooled and allowed to develop ultimate properties of strength and integrity, preferably by calendering, extrusion, injection and compression moulding.
13. The process according to the preceding clause, carried out at temperatures in the range of 130 to 210° C.
14. The process according to clause 12 or 13, carried out in two steps, forming an intermediate first in a first step and combining the intermediate with the remainder of the components in a second step.
15. A solid article comprising the polymer composite according to any of the preceding clauses 1-11.
16. The solid article according to the preceding clause, in the form of a compounded pellet, extruded work-piece, injection-moulded article, blow moulded article, film or rota-moulded plastic article, two-part liquid moulded article, laminate, 3D printer filament, felt, woven fabric, knitted fabric, embroidered fabric, nonwoven fabric, geotextiles, fibre or a solid sheet.
17. The solid article according to clause 15 or 16, in the form of a coffee pod, cutlery, food tray, or single-serve packaging.
18. An intermediate as prepared by the process according to clause 14, for use in the preparation of a polymer composite according to any of the preceding clauses 1-11.

What is claimed is:

1. A polymer composite having an overall weight, comprising:
(a) A biodegradable polymer in an amount of 5-94.5% by weight of the overall weight;
(b) whole grain flour of cereal grass, in an amount of at least 5% by weight of the overall weight; and
(c) a plasticizer in an amount from 5-50% w/w of the whole grain flour of cereal grass;
wherein the plasticizer is a solid plasticizer having a melting temperature in the range of 70 to 210° C.

2. The polymer composite of claim 1, wherein the biodegradable polymer is chosen from polyglycolide (PGA), polylactide or poly(lactic acid) (PLA), poly(lactide-co-glycolide) (PLGA), polycaprolactone (PCL), poly(butylene succinate) (PBS) and its copolymers, poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB), polyhydroxyalkanoates (PHA), poly(hydroxybutyrate-co-hydroxyvalerate) (PHBV), and mixtures, derivatives, and polymer blends thereof.

3. The polymer composite of claim 1, wherein the biodegradable polymer is present in an amount of 30-70% by weight of the overall weight.

4. The polymer composite of claim 1, wherein the whole grain flour of cereal grass is chosen from milled whole triticale seeds, milled whole oat groats, milled whole millet seeds, milled whole canary seeds, and mixtures thereof.

5. The polymer composite of claim 1, comprising a mixture of whole grain flour of cereal grass and up to 100% w/w of whole grain flour of cereal grass chosen from milled expeller/meal/cake, milled pomace, milled distillers' grain, milled brewer's grain, brewer's spent grain/draft milled biscuit meal and individual components thereof, coffee grounds, milled whole seeds, milled whole roots, milled whole beans, milled stems and leaves, flour of pulse, and mixtures thereof.

6. The polymer composite of claim 1, wherein the whole grain flour of cereal grass is present in an amount of 20-70% by weight of the overall weight.

7. The polymer composite of claim 1, wherein the plasticizer is chosen from polyols, polyfunctional alcohols, amphipolar plasticizers, carboxylic acids and esters, mono, di-, and tri-glyceride esters, mono-, di- and oligosaccharides, and mixtures thereof.

8. The polymer composite of claim 1, wherein the plasticizer is chosen from xylose, sorbitol and xylitol.

9. The polymer composite of claim 8, wherein the plasticizer comprises xylitol.

10. The polymer composite of claim 1, wherein the plasticizer is present in an amount from 22-40% w/w of the whole grain flour of cereal grass.

11. The polymer composite of claim 1, further comprising a filler chosen from a natural fibre, cellulose, lignocellulose fibres, a mineral filler, carbonates, bicarbonates, phosphates, ferrocyanides, silica, silicates, aluminosilicates, clay minerals, mica, talc, titanium dioxide, a carbon-based filler, and combinations thereof.

12. The polymer composite of claim 1, further comprising a filler present in an amount of 1-40% by weight of the overall weight.

13. The polymer composite of claim 1, further comprising an additive chosen from compatibilizers, fragrances, heat and UV stabilizers, colouring agents, and mixtures thereof.

14. A process for preparing a polymer composite comprising: a biodegradable polymer; whole grain flour of cereal grass; and a plasticizer; wherein the plasticizer is a solid plasticizer having a melting temperature in the range of 70 to 210° C. as components, the process comprising combining the components under heat and shearing forces, forming a molten plastic; shaping the molten plastic into a form using a method chosen from calendering, extrusion, injection and compression moulding; and cooling the form for a sufficient time to develop strength and integrity thereof.

15. The process of claim 14, wherein said step of combining the components is carried out at temperatures in the range of 130 to 215° C.

16. The process of claim 14, comprising the steps of forming an intermediate from at least one component; and combining the intermediate with the previously unused components.

17. A solid article comprising a biodegradable polymer; whole grain flour of cereal grass; and
a plasticizer; wherein the plasticizer is a solid plasticizer having a melting temperature in the range of 70 to 210° C.

18. The solid article of claim 17 having a form chosen from a compounded pellet, an extruded work-piece, an injection-moulded article, a blow moulded article, a rota-moulded plastic article, a two-part liquid moulded article, a laminate, a 3D printer filament, felt, woven fabric, knitted fabric, embroidered fabric, nonwoven fabric, geotextiles, a fibre and a solid sheet.

19. The solid article of claim 17 having a form chosen from a coffee capsule, cutlery, a straw, a drink stirrer, a food tray, a single-serve packaging, such as a cup, cap, container, and container lid, and a single-use item.

20. The polymer composite of claim 3, wherein the biodegradable polymer is present in an amount of 30-50% by weight of the overall weight.

21. The polymer composite of claim 5, wherein the mixture is present in an amount of 20-70% by weight of the overall weight.
